(19) United States
(12) Patent Application Publication
(10) Pub. No.: US 2021/0217000 A1
(43) Pub. Date: Jul. 15, 2021

(54) COMPUTING DEVICES FOR ACTION PRECONDITION FULFILLMENT

(71) Applicant: Wells Fargo Bank, N.A., San Francisco, CA (US)

(72) Inventor: Chris Theodore Kalaboukis, San Jose, CA (US)

(21) Appl. No.: 15/382,134

(22) Filed: Dec. 16, 2016

(51) Int. Cl. G06Q 20/36; G06Q 20/34; A63F 13/69

(52) U.S. Cl. CPC G06Q 20/36; A63F 13/69; G06Q 20/341

(57) ABSTRACT

Disclosed in some examples are methods, systems, devices and machine readable mediums for behavior modification through the use of computing devices of the user to fulfill tasks that are designated by the user as preconditions to certain actions. These actions involve one or more computing devices for their achievement. Tasks are completed using one or more applications on the computing device of the user. Once the task is completed, the action is allowed

### TECHNICAL FIELD

Embodiments pertain to computing devices for fulfilling action preconditions. Some embodiments relate to computing devices for fulfilling action preconditions for actions involving other computer systems.

### BACKGROUND

Mobile devices are becoming more and more ubiquitous as the capabilities of these devices increase. Mobile devices are now capable of executing very advanced software applications and are capable of communicating with many other computing devices using wireless technologies such as cellular, Wireless Local Area Networks (WLAN), BLUETOOTH®, Near Field Communications (NFC), and the like. Indeed, many mobile devices may simultaneously communicate using several of these technologies.

### BRIEF DESCRIPTION OF THE DRAWINGS

In the drawings, which are not necessarily drawn to scale, like numerals may describe similar components in different views. Like numerals having different letter suffixes may represent different instances of similar components. The drawings illustrate generally, by way of example, but not by way of limitation, various embodiments discussed in the present document.

FIG. 1 is a schematic of a system for operation of computing devices for precondition task fulfillment according to some examples of the present disclosure.

FIG. 2 is a flowchart of a method of determining whether an action precondition is satisfied according to some examples of the present disclosure.

FIG. 3 is a schematic of an action authorization computing device used to authorize or perform an action as well as a user computing device according to some examples of the present disclosure.

FIG. 4 is a block diagram illustrating an example of a machine upon which one or more embodiments may be implemented.

### DETAILED DESCRIPTION

The ubiquitous natures of computing devices and computer networks (such as the Internet) as well as easy access to credit cards have decreased barriers to spending. For example, consumers used to have to have physically drive to a store and use money in the form of cash to make a purchase. But now they can easily purchase goods or services from their homes with a click of a button using widely available credit. As a result, it becomes extremely easy for a user to purchase outside of their budget, make transactions over self-imposed limits, and difficult for them to control their own behavior.

Disclosed in some examples are methods, systems, devices and machine readable mediums for behavior modification through the use of computing devices of the user to fulfill tasks that are designated by the user as preconditions to certain actions. One example action is completing a purchase—prior to completing a purchase, a user must complete a task such as using an application on their mobile device for a predetermined period of time (e.g., playing a game for 5 minutes). The task may be otherwise unrelated to the action normally. For example, the action may not be related to a computer-based gaming task. Once the task is completed, the transaction is allowed. The use of a distracting task prior to completion of an action (such as a transaction) adds additional hurdles to what otherwise would be a painless (and even rewarding) action. It thus provides users with an opportunity (while working on satisfying the condition) to change their mind and provides a mental barrier to wanting to engage in certain actions in the first place.

While the specification herein uses a transaction such as a purchase as one example of an action with a precondition, one of ordinary skill will understand that the systems, methods, and machine readable mediums described herein can be used with other actions as well. For example, a user may wish to eat healthier. In these examples, the action may be the purchase of certain foods. In other examples, users may wish to reduce the amount of certain media they consume (e.g., online gaming). In these examples, the precondition task may be a certain amount of exercise.

As used herein, actions are behaviors that utilize computer systems (e.g., action authorization computing devices) for their achievement. For example, a payment transaction using a credit card for payment may involve messaging between a merchant computer system, an acquirer computer system (e.g., the merchant's bank), a card network computer system, an issuer's computer system, and the like to approve and fund the transaction. Tasks that are preconditions to actions are tasks that must be satisfied for an action to be allowed by the computer systems. Tasks that are preconditions to actions are capable of being monitored by, or achieved with, a computing device of the user (which may, or may not be a computer system that participates in the action). Thus performing a task by a computing device of a user may be a condition precedent to the processing of an action on other, external, computer systems.

Prior to completion of the task, the action may be blocked by one of the computing devices participating in the action until an indication is received that the task was completed from the computing device of the user. In some examples, these computer devices may be acquirer computer systems, issuer computer systems, merchant computer systems, card network computer systems, and the like. In other examples, the action may be blocked by the computing device of the user—e.g., the user may be trying to complete a transaction via a mobile wallet application on the computing device of the user. In these examples, the mobile wallet application may be blocked from passing payment details to the merchant or other computing device until the task is complete.

Monitoring the completion of a task may be accomplished by use of a task monitoring module on a computing device (e.g., a mobile device) of the user. The task monitoring module communicates fulfillment or non-fulfillment of the task to one or more computing devices that are participating in the action (e.g., a credit card server, a mobile wallet on the computing device, or the like) to allow the action.

Tasks are interactions with a computerized device of the user, such as utilizing an application on the mobile device (e.g., playing a game), performing a physical action (e.g., raising the mobile device over the user's head a predetermined number of times), and the like. In some examples, when the task relates to utilizing an application on the mobile device, the task may involve reaching a predetermined objective or state of the application. Examples include using the application for a predetermined period of time, completing an objective in the application (such as reaching a particular level or goal), or the like. Task completion may be required to be within a predetermined temporal proximity to the desired action to constitute satisfaction of the task precondition for the action. For example, the task may be required to be completed 10 minutes before, or 10 minutes after (e.g., a 20 minute window) of initiation of the action.

Task preconditions, as used herein, do not include the normal activities necessary for engaging in the action. For example, in engaging in a transaction, normal actions necessary for engaging in the action include navigating to a merchant's website, clicking on icons/graphics within that site, entering payment information, messaging between various computer systems to approve the transaction and transfer payment, and the like. In the case of a physical merchant, normal actions necessary for engaging in the transaction including bringing products to the checkout counter, scanning the items, handing over or transmitting payment information, messaging between various computer systems to approve the transaction and transfer payment, and the like, signing a slip, and the like.

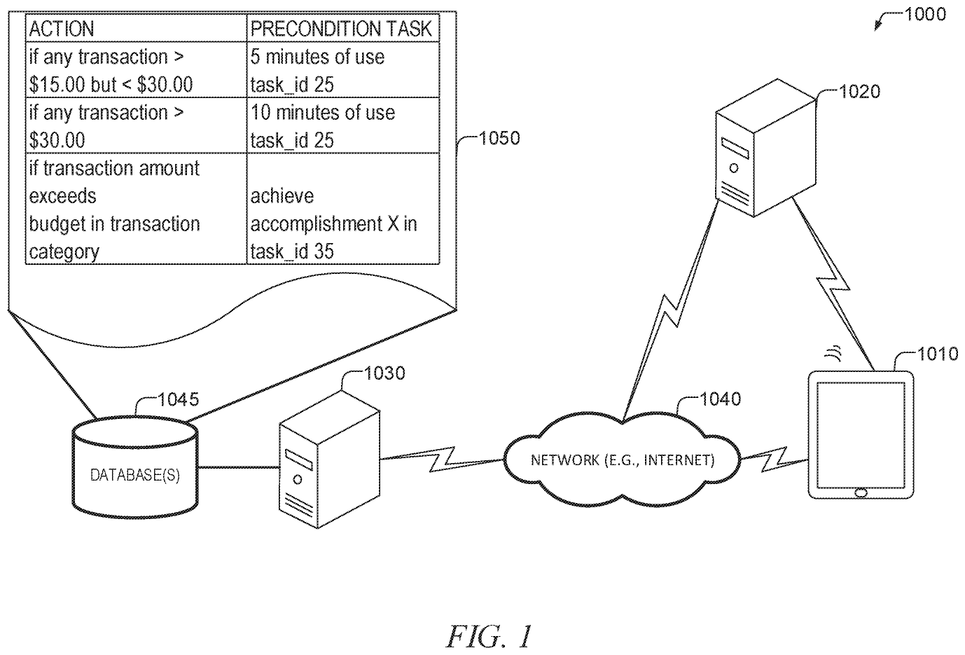

Turning now to FIG. 1, a schematic of a system 1000 for operation of computing devices for precondition task fulfillment is shown according to some examples of the present disclosure. In FIG. 1, the action is a purchase transaction. Users may initiate a transaction manually (e.g., provide a credit card), or utilize computing device 1010 (e.g., a mobile device) to initiate a transaction. For example, computing device 1010 may communicate with a merchant computing device 1020, such as a point of sale device (POS), e-commerce server, or the like to provide payment information of the user for a transaction to a merchant computing system. Merchant computing device 1020 may communicate with action authorization computing device 1030 (such as a payment processing computer such as a credit card issuer or acquirer system) to authorize the transaction. For example, the merchant system 1020 may send the payment information received from the user or received from the user's computing device 1010 through network 1040 to action authorization computing device 1030 for authorization to proceed with the payment.

In some examples, action authorization computing device 1030 may include or be communicatively coupled to a database 1045. Database 1045 may store one or more user profiles. These profiles may include information about one or more users. This profile information may include payment information, demographic information, financial information (e.g., balances, payments, spending habits) and the like. Additionally, this profile information may contain information about any user specified preconditions for actions. For example, a precondition task table 1050 which shows actions in one column and corresponding tasks required to perform the action in a second column. Thus, for example, a transaction that is over $15.00 but less than $30.00 requires that the user use or otherwise interact with an application with a particular identifier (e.g., task id 25).

Precondition tasks may be static—that is, each action of a particular type (e.g., a payment, a withdrawal, a transfer) may require the same task. Precondition tasks may vary depending on the type—that is, a payment may require a different task than a withdrawal. In other examples, within action types, various task levels may be defined which change based upon the details of the action. For example, as shown in FIG. 1, tasks may become more difficult as the dollar value of the transaction increases. Precondition tasks may thus depend on action information (e.g., payment amount). In additional, the precondition task may vary based on past action history or financial information. For example, a user may wish to increase a task difficulty based upon on a total amount spent, a budgeted amount remaining, or the like. For example, as a particular transaction category (e.g., food, utility bills, gas, entertainment) nears or exceeds a budgeted amount, a task may be added, or may become more difficult to meet. In some examples, multiple tasks may be required prior to an action. The budgeted amount as well as task difficulty thresholds may be specified by a user when establishing the precondition task table 1050.

Upon receiving a request to approve an action, action authorization computing device 1030 checks to determine if the user has completed a task required for the approval of that action by consulting the precondition task table 1050. If a precondition task is established for the action, the authorization server determines if the task has been completed. For example, the user's computing device 1010 may communicate completion of the task to the authorization server 1030. This communication may be directly (e.g., through a computer network) or through the merchant computing device 1020. If the task was satisfied within a predetermined temporal limit, the action authorization computing device 1030 may authorize the action (assuming other conditions necessary for the action are met—such as sufficient credit). For example, the action authorization computing device 1030 may request an indication of whether or not the task was completed from the computing device 1010. In some examples, the request triggers the computing device 1010 to prompt the user to perform the task. For example, a GUI may be displayed which may prompt the user to “play 5 minutes of the game GalaxyZoomer to unlock this transaction.” In some examples, the user may have already completed the task prior to the initiating the transaction. Task completion may be bounded by a temporal window. For example, the task may be required to be completed within a temporal window of 15 minutes before to 15 minutes after the initiation of the transaction.

To setup which actions correspond to which preconditions, users may setup an account with the action authorization computing device 1030 or with another computing device that is communicatively coupled to the database 1045. The action authorization computing device 1030 may provide one or more graphical user interfaces (GUI) to provide users the ability to sign up for, view, edit, delete, and otherwise modify the actions and associated precondition tasks. The GUIs may be provided by the action authorization computing device 1030 upon request to computing devices (such as computing device 1010) of the user through one or more GUI descriptors. GUI descriptors may include one or more files which are renderable by a general rendering application, such as a browser application, or by a specialty application (e.g., such as an application designed to implement the functionality described herein) to provide a GUI. Example GUI descriptors include HyperText Markup Language (HTML) files, eXtensible Markup Language (XML) files, JavaScript files, scripting files, Content Style Sheets (CSS), and the like. In other examples, GUI descriptors may provide information which is used by a dedicated application on the computing device of the user 1010 to create one or more GUIs. In some examples, other computing devices other than the action authorization computing device 1030 may setup and manage user profiles and accounts. GUIs may allow users to sign up, set precondition tasks for various actions, delete preconditions, and the like.

While the example of FIG. 1 showed an action authorization computing device 1030 implementing the precondition task checking, in other examples, where the action utilizes the computing device 1010, the computing device 1010 may implement the precondition task checking. For example, the user may wish to utilize a payment item in a mobile wallet application on the computing device 1010 to pay for the transaction. In these examples, the mobile device 1010 may store or have access to the precondition task table 1050 of the user (either the only copy or a copy). The mobile device 1010 may then verify if and when the task was completed and allow access to, or deny access to, the mobile wallet for use in paying. In some examples, both the action authorization computing device 1030 and the mobile device 1010 may have access to the precondition task table 1050 (or a portion of it). For example, the precondition task table 1050 accessed by the action authorization computing device 1030 may specify precondition tasks for actions relevant to purchases made with traditional payment devices (e.g., physical credit cards) and the precondition task table 1050 accessed by the mobile device 1010 may specify precondition tasks for actions relevant to purchases made with mobile wallet applications or other mobile payment forms.

Computing device 1010 (shown as a mobile device) may track user completion of tasks, provide functionality necessary to complete the tasks (e.g., execute one or more applications), prompt users to complete tasks, allow users to pay using one or more mobile wallet applications, and the like. In examples in which the mobile device includes the precondition task table 1050 and determines whether the tasks were completed, the mobile device 1010 may have a dedicated application which may perform the functions of creating the user profiles (including creating and populating the precondition task table 1050), tracking task completions, and authorizing (or declining) access to a mobile wallet or other means for performing the action (e.g., blocking access to certain websites prior to completing a task).

In some examples, rather than controlling action completion through controlling access to applications and functionality on the mobile device 1010 itself, the dedicated application on the mobile device 1010 may ensure precondition task fulfillment by communicating with external computing devices. For example, the mobile device 1010 may communicate with the authorization server 1030 and may indicate that precondition tasks are enabled (authorization server 1030 may not know the preconditions). In these examples, the dedicated application will send a message at the time of a transaction to the authorization computing device 1030 indicating (e.g., yes or no) whether the precondition task (as stored in the mobile device 1010) have been completed.

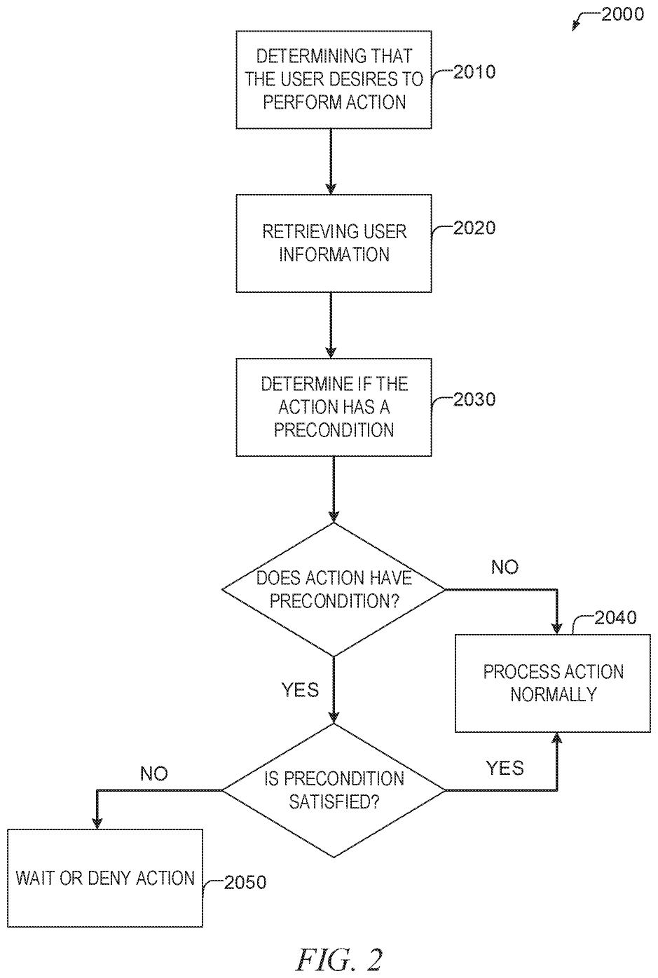

Turning now to FIG. 2, a flowchart of a method 2000 of determining whether an action precondition is satisfied according to some examples of the present disclosure. The method 2000 may be performed by either an action authorization computing device (such as a transaction authorization computing device) or a user's computing device depending on the particular embodiment. At operation 2010, the computing device determines that the user desires to perform a particular action. For example, purchasing goods or services from a merchant. This determination may be made based upon a message or other communication received from a merchant computer system (in the case that the authorization server is executing FIG. 2) or based upon an input into the computing device of the user (e.g., an attempt to use a digital wallet to pay for a purchase or by clicking “checkout” or an equivalent control on a merchant website).

At operation 2020, the computing device retrieves user information. For example, the computing device may retrieve a profile of the user. The user information may be retrieved from storage, either on the device, or by requesting it from another computing device over a network. The user information may include information on whether any precondition tasks are setup for any actions. For example, the information may contain (or contain a reference to) a precondition task table. The computing device may also retrieve financial information (e.g., past amounts spent) for the user if it is necessary to determine whether a precondition task is applicable to an action. The financial information may be retrieved from storage, either on the device, or by requesting it from another computing device over a network.

At operation 2030 the computing device may determine from the user information if the desired action of the user (as determined by operation 2010) has a required task. If the action does not have a precondition task (as that term is used herein), the computer system processes the action normally at operation 2040. Processing the action normally may include operations such as transmitting payment information, determining whether to approve the transaction based upon credit limits, fraud detection, allowing access to a mobile wallet, allowing access to one or more websites or web addresses, and the like.

If a precondition task is present, a determination is made whether the task was completed or not. In some examples, the determination may be made by a computing device of the user and (if necessary) communicated to the authorization server. The determination may be made by passively monitoring the computing device of the user, utilizing an Application Programming Interface (API) to query one or more other applications on the mobile device as to the user's status, providing and monitoring the precondition task and the like.

If the precondition is satisfied, then the action may be processed normally at operation 2040. In some examples, the system may allow a user a predetermined amount of time to complete the task after the commencement of the method 2000. At operation 2050, if the task is not completed, the system may wait the predetermined amount of time. If the task is not completed within the predetermined period of time, the action may be refused.

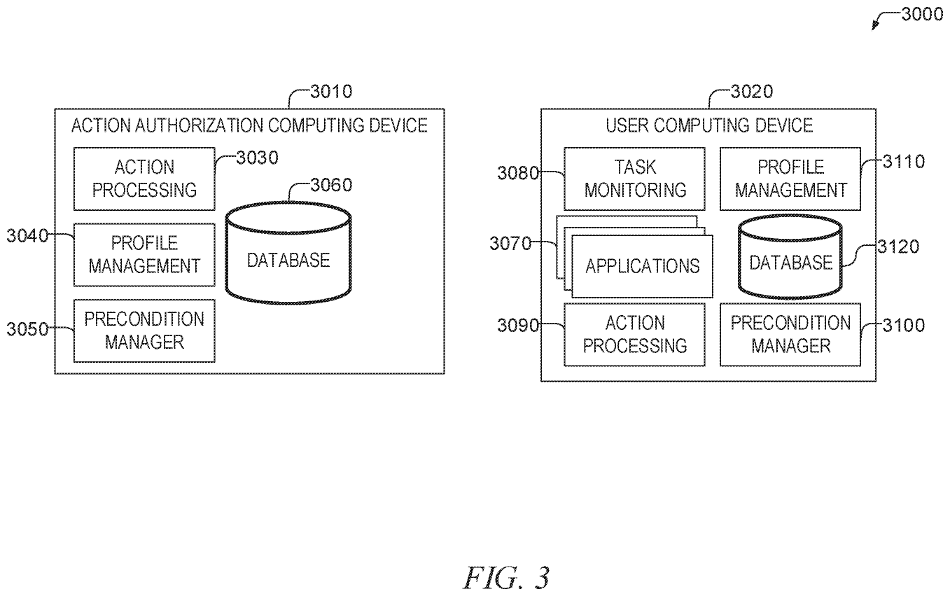

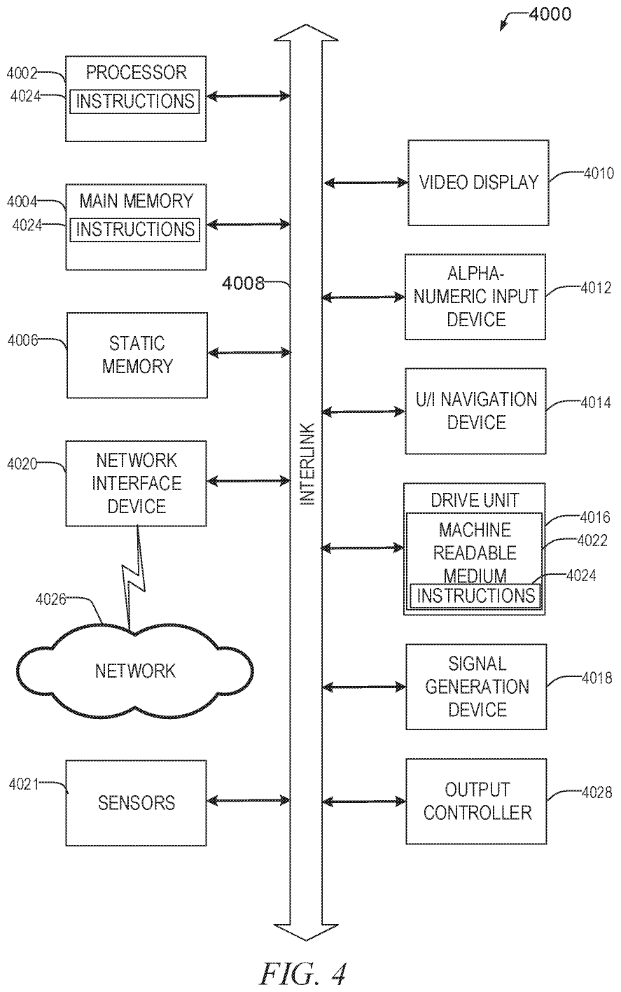

Turning now to FIG. 3, a schematic 3000 of an action authorization computing device 3010 used to authorize or perform an action as well as a user computing device 3020 are shown according to some examples of the present disclosure. FIG. 3 features one or more modules. Modules are circuits that are configured so as to provide certain functionality. These circuits may be created by instructions on a computer readable medium that configures general purpose circuitry to perform the provided functionality, or may be specifically created circuits. The functionality for the modules of FIG. 3 is exemplary and other divisions of functionality among the modules shown, or the addition of modules not shown, or the subtraction of modules shown, may be utilized. In some examples the modules as shown in FIG. 3 may be distributed across more than a single computing device. Modules are discussed more with respect to the discussion of FIG. 4.

Action authorization computing device 3010 may be an example implementation of action authorization computing device 1030 from FIG. 1. Action authorization computing device 3010 may have an action processing module 3030 which may process the action. For example, the action processing module 3030 may determine whether a transaction is to be allowed based upon the user's credit limit, unpaid balance, likelihood of fraud, and the like. Action processing module 3030 may also access a database 3060 which may store user information (e.g., financial information, demographic information), and may also store precondition task tables. Action processing module 3030 may check to determine whether the action has a required precondition task and whether that task has been completed and if not may deny the action. If the task has been completed and the action would otherwise be allowed or completed, then the action processing module may allow or complete the action. Example actions include approving transactions (e.g., credit card transactions), allowing access to media (e.g., videos, online gaming, music, television shows), accessing one or more applications, allowing access to one or more communications programs (e.g., instant messaging, chats, Short Message Services (SMS)), and the like.

Profile management module 3040 may provide one or more GUIs to user computing devices (such as user computing device 3020) to allow users to setup profiles, manage profiles, delete profiles, and otherwise manipulate their profiles. This includes entering, modifying, editing, deleting, creating, or otherwise changing precondition tasks and specifying actions for those precondition tasks. The GUIs may be provided via one or more GUI descriptors. The profile and the precondition tasks may be saved in the database 3060. Database 3060 may be part of the action authorization computing device 3010 or may be separate, but communicatively coupled through one or more computer networks. Precondition manager 3050 may communicate with the user computing device 3020 to determine whether a precondition task has been completed. Precondition manager may inform action processing module 3030 upon completion of the precondition task.

User computing device 3020 includes one or more applications 3070. Applications 3070 may be assigned application identifiers (IDs) which may be utilized to specify application related tasks in the precondition task tables. Applications include games, productivity applications, sensor applications (e.g., GPS sensors, motion sensors, and the like), communication applications, operating system applications, and the like. Applications may be off-the-shelf applications that are not created specifically to serve as a precondition to an action. In other examples, applications may be specially created to serve as a precondition to an action.

In some examples in the user computing device 3020 may have a task monitoring module 3080 which monitors applications 3070 for precondition task achievement. Applications 3070 may be monitored for task completion continuously or monitored temporally proximate an action. Applications may be monitored through indirect monitoring (e.g., querying an operating system of the user computing device 3020 about task execution (including execution time, input focus to ensure the user isn't running the task solely in the background, and the like)), or by directly communicating with the task through an Application Programming Interface (API). Additionally tasks may be monitored based upon the task's communication activities. For example, games with a social networking component may post messages to the social networking service about achievements in the game.

Task completion may be communicated by the task monitoring module 3080 with an action authorization computing device 3010, or in some examples, with other components of the user computing device 3020 such as action processing module 3090.

In examples in which the action is performed (or allowed to proceed) by user computing device (such as unlocking a mobile wallet, allowing website access, or the like once a precondition task has been completed), an action processing module 3090 in some examples may process at least part of the requested action. For example, the action processing module 3090 may receive a request to access to a mobile wallet application for engaging in a transaction. The action processing module 3090 may determine, by accessing database 3120, if any task preconditions are present. If the task preconditions are not present, or are completed, then the action processing module 3090 may allow access to the payment item in the mobile wallet application to pay for the transaction. If task preconditions are present, and are not completed, then the action processing module 3090 may wait until the temporal time window has elapsed before denying the action. Additionally, once the temporal window has elapsed, the user may attempt again to perform the action. This will result in the resetting of the temporal window and allow a further opportunity for the user to perform the precondition task. In some examples, the action processing module 3090 will prompt the user to complete the precondition task and in some examples may automatically launch an application from applications 3070 to allow the user to complete the task.

Database 3120 may store user information (e.g., financial information, demographic information), and may also store precondition task tables. Database 3120 may be stored in memory of the user computing device 3020 or may be external to the user computing device 3020 but accessible via one or more computer networks.

As with profile management module 3040, profile management module 3110 may provide one or more GUIs to allow users to setup profiles and to enter and manage precondition tasks. The profile and the precondition tasks may be saved in the database 3120. Precondition manager 3100 may communicate with the action authorization computing device 3010 in some examples to inform the action authorization computing device 3010 that a precondition task has been completed.

FIG. 4 illustrates a block diagram of an example machine 4000 upon which any one or more of the techniques (e.g., methodologies) discussed herein may perform. In alternative embodiments, the machine 4000 may operate as a standalone device or may be connected (e.g., networked) to other machines. In a networked deployment, the machine 4000 may operate in the capacity of a server machine, a client machine, or both in server-client network environments. In an example, the machine 4000 may act as a peer machine in peer-to-peer (P2P) (or other distributed) network environment. The machine 4000 may implement in whole or in part the action authorization computing device 3010, the user computer device 3020, and the method of claims 2. Machine 4000 may be a server computer, personal computer (PC), a tablet PC, a set-top box (STB), a personal digital assistant (PDA), a mobile telephone, a smart phone, a web appliance, a network router, switch or bridge, or any machine capable of executing instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein, such as cloud computing, software as a service (SaaS), other computer cluster configurations.

Examples, as described herein, may include, or may operate on, logic or a number of components, modules, or mechanisms. Modules are tangible entities (e.g., hardware) capable of performing specified operations and may be configured or arranged in a certain manner. In an example, circuits may be arranged (e.g., internally or with respect to external entities such as other circuits) in a specified manner as a module. In an example, the whole or part of one or more computer systems (e.g., a standalone, client or server computer system) or one or more hardware processors may be configured by firmware or software (e.g., instructions, an application portion, or an application) as a module that operates to perform specified operations. In an example, the software may reside on a machine readable medium. In an example, the software, when executed by the underlying hardware of the module, causes the hardware to perform the specified operations.

Accordingly, the term “module” is understood to encompass a tangible entity, be that an entity that is physically constructed, specifically configured (e.g., hardwired), or temporarily (e.g., transitorily) configured (e.g., programmed) to operate in a specified manner or to perform part or all of any operation described herein. Considering examples in which modules are temporarily configured, each of the modules need not be instantiated at any one moment in time. For example, where the modules comprise a general-purpose hardware processor configured using software, the general-purpose hardware processor may be configured as respective different modules at different times. Software may accordingly configure a hardware processor, for example, to constitute a particular module at one instance of time and to constitute a different module at a different instance of time.

Machine (e.g., computer system) 4000 may include a hardware processor 4002 (e.g., a central processing unit (CPU), a graphics processing unit (GPU), a hardware processor core, or any combination thereof), a main memory 4004 and a static memory 4006, some or all of which may communicate with each other via an interlink (e.g., bus) 4008. The machine 4000 may further include a display unit 4010, an alphanumeric input device 4012 (e.g., a keyboard), and a user interface (UI) navigation device 4014 (e.g., a mouse). In an example, the display unit 4010, input device 4012 and UI navigation device 4014 may be a touch screen display. The machine 4000 may additionally include a storage device (e.g., drive unit) 4016, a signal generation device 4018 (e.g., a speaker), a network interface device 4020, and one or more sensors 4021, such as a global positioning system (GPS) sensor, compass, accelerometer, or other sensor. The machine 4000 may include an output controller 4028, such as a serial (e.g., universal serial bus (USB), parallel, or other wired or wireless (e.g., infrared(IR), near field communication (NFC), etc.) connection to communicate or control one or more peripheral devices (e.g., a printer, card reader, etc.).

The storage device 4016 may include a machine readable medium 4022 on which is stored one or more sets of data structures or instructions 4024 (e.g., software) embodying or utilized by any one or more of the techniques or functions described herein. The instructions 4024 may also reside, completely or at least partially, within the main memory 4004, within static memory 4006, or within the hardware processor 4002 during execution thereof by the machine 4000. In an example, one or any combination of the hardware processor 4002, the main memory 4004, the static memory 4006, or the storage device 4016 may constitute machine readable media.

While the machine readable medium 4022 is illustrated as a single medium, the term “machine readable medium” may include a single medium or multiple media (e.g., a centralized or distributed database, and/or associated caches and servers) configured to store the one or more instructions 4024.

The term “machine readable medium” may include any medium that is capable of storing, encoding, or carrying instructions for execution by the machine 4000 and that cause the machine 4000 to perform any one or more of the techniques of the present disclosure, or that is capable of storing, encoding or carrying data structures used by or associated with such instructions. Non-limiting machine readable medium examples may include solid-state memories, and optical and magnetic media. Specific examples of machine readable media may include: non-volatile memory, such as semiconductor memory devices (e.g., Electrically Programmable Read-Only Memory (EPROM), Electrically Erasable Programmable Read-Only Memory (EEPROM)) and flash memory devices; magnetic disks, such as internal hard disks and removable disks; magneto-optical disks; Random Access Memory (RAM); Solid State Drives (SSD); and CD-ROM and DVD-ROM disks. In some examples, machine readable media may include non-transitory machine readable media. In some examples, machine readable media may include machine readable media that is not a transitory propagating signal.

The instructions 4024 may further be transmitted or received over a communications network 4026 using a transmission medium via the network interface device 4020. The Machine 4000 may communicate with one or more other machines utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 802.11 family of standards known as Wi-Fi®, IEEE 802.16 family of standards known as WiMax®), IEEE 802.15.4 family of standards, a Long Term Evolution (LTE) family of standards, a Universal Mobile Telecommunications System (UMTS) family of standards, peer-to-peer (P2P) networks, among others. In an example, the network interface device 4020 may include one or more physical jacks (e.g., Ethernet, coaxial, or phone jacks) or one or more antennas to connect to the communications network 4026. In an example, the network interface device 4020 may include a plurality of antennas to wirelessly communicate using at least one of single-input multiple-output (SIMO), multiple-input multiple-output (MIMO), or multiple-input single-output (MISO) techniques. In some examples, the network interface device 4020 may wirelessly communicate using Multiple User MIMO techniques.

1. A computing device comprising:
a processor;
a memory coupled to the processor and comprising instructions, which when performed by the processor, cause the computing device to perform operations to:
determine that a user has requested to perform an action;
retrieve a user profile data structure from a database;
determine that the user profile data structure specifies a particular task that is to be performed with a user computing device as a precondition to allow approval of the action, the task specifying an achievement of the user in a computer-based game executed on a user computing device, wherein the action is unrelated to the computer-based game;
transmit computing instructions to the user computing device to instantiate a graphical user interface for receiving user interaction for completion of the task;
determine, from the user profile data structure, a temporal window for completing the action;
communicate with software executing on the user computing device to receive input that is evaluated to determine whether the task was completed based data included in the input indicating user interaction via the graphical user interface; and
block the action until it is determined that the task was completed within the temporal window, and upon determination that task was completed during the temporal window, perform at least part of the action.

2. The computing device of claim 1, wherein the action is a purchase with a credit card from a merchant, and wherein the instructions to determine that the user has requested to perform an action comprises instructions to receive a payment request from a computing device of the merchant, wherein the computing device of the merchant is different than the computing device and the user computing device.

3. The computing device of claim 2, the instructions to block the action further comprising instructions that cause the computing device to perform operations to:
notify the computing device of the merchant that the purchase is declined.

4. The computing device of claim 1, wherein the action is a purchase from a merchant and the instructions to block the action further comprising instructions that cause the computing device to perform operations to:
cause a mobile wallet application on the user computing device to prevent transmission of payment details to a computing device of the merchant.

5. The computing device of claim 1, wherein the user computing device is a mobile device of the user that includes a cellular transmitter, and the instructions to determine whether the task was completed further comprising instructions that cause the computing device to perform operations to identify receipt or a failure to receive, over a network, an indication from the computer-based game executing on the user computing device that the precondition is satisfied.

6. (canceled)

7. The computing device of claim 1, the instructions to determine that the user has requested to perform the action further comprising instructions that cause the computing device to perform operations to receive a request to pay for a transaction at a mobile wallet application executing on the user computing device, and in response to a determination that the action was not completed, cause the user computing device to display a prompt to complete the task.

8. The computing device of claim 1, wherein the achievement of the user in the computer-based game comprises the user playing the game for a predetermined amount of time, and the instructions to communicate with software executing on the user computing device to determine whether the task was completed further comprising instructions that cause the computing device to perform operations to receive a data structure from the user computing device that indicates that the user played the game on the user computing device for the predetermined amount of time.

9. The computing device of claim 1, the memory further comprising instructions that cause the computing device to perform operations to receive an identification of the task and an identification of the precondition from the user computing device.

10. The computing device of claim 1, the memory further comprising instructions that cause the computing device to perform operations to retrieve, over a network, financial data about the user and wherein the achievement of the user in the computer-based game changes depending on a past amount spent by the user as determined from the financial data of the user.

11. A machine-readable medium, comprising instructions, which when performed by a machine, cause the machine to perform operations to:
determine that a user has requested to perform an action;
retrieve a user profile data structure from a database;
determine that the user profile data structure specifies a particular task that is to be performed with a user computing device as a precondition to allow approval of the action, the task specifying an achievement of the user in a computer-based game executed on the user computing device, wherein the action is unrelated to the computer-based game;
transmit computing instructions to the user computing device to instantiate a graphical user interface for receiving user interaction for completion of the task;
determine, from the user profile data structure, a temporal window for completing the action;
communicate with software executing on the computing device of the user to receive input that is evaluated to determine whether the task was completed based data included in the input indicating user interaction via the graphical user interface; and
block the action until it is determined that the task was completed within the temporal window, and upon determination that the task was completed during the temporal window, perform at least part of the action.

12. The machine-readable medium of claim 11, wherein the action is making a purchase with a credit card from a merchant, and the instructions to determine that the user has requested to perform an action further comprising instructions that cause the machine to perform operations to receive a payment request from a computing device of the merchant, the computing device of the merchant different than the machine and the user computing device.

13. The machine-readable medium of claim 12, the instructions to block the action further comprising instructions that cause the machine to perform operations to:
notify the computing device of the merchant that the purchase is declined.

14. The machine-readable medium of claim 11, wherein the action is a purchase from a merchant and the instructions to block the action further comprising instructions that cause the machine to perform operations to:
cause a mobile wallet application on the user computing device to prevent transmission of payment details to a computing device of the merchant.

15. The machine-readable medium of claim 11, wherein the user computing device is a mobile device of the user that includes a cellular transmitter, and the instructions to determine whether the task was completed further comprising instructions that cause the machine to perform operations to identify receipt or a failure to receive, over a network, an indication from the computer-based game executing on the user computing device that the precondition is satisfied.

16. (canceled)

17. The machine-readable medium of claim 11, the instructions to determine that the user has requested to perform the action further comprising instructions that cause the machine to perform operations to identify receipt or a failure to receive a request to pay for a transaction at a mobile wallet application executing on the user computing device, and in response to a determination that the action was not completed, cause the user computing device to display a prompt to complete the task.

18. The machine-readable medium of claim 11, wherein the achievement of the user in the computer-based game comprises the user playing the game for a predetermined amount of time, and the instructions to communicate with software executing on the user computing device to determine whether the task was completed further comprising instructions that cause the machine to perform operations to receive a data structure from the user computing device that indicates that the user played the game on the user computing device for the predetermined amount of time.

19. The machine-readable medium of claim 11, further comprising instructions that cause the machine to perform operations to receive an identification of the task and an identification of the precondition from the user computing device.

20. The machine-readable medium of claim 11, further comprising instructions that cause the machine to perform operations to retrieve, over a network, financial data about the user and wherein the achievement of the user in the computer-based game changes depending on a past amount spent by the user as determined from the financial data of the user.

21. A method performed by a computing device, the method comprising:
using one or more computer processors:
determining that a user has requested to perform an action;
retrieving a user profile data structure from a database;
determining that the user profile data structure specifies a particular task that is to be performed with a user computing device as a precondition to allow approval of the action, the task specifying an achievement of the user in a computer-based game executed on the user computing device, wherein the action is unrelated to the computer-based game;
transmitting computing instructions to the user computing device to instantiate a graphical user interface for receiving user interaction for completion of the task;
determining, from the user profile data structure, a temporal window for completing the action;
communicating with software executing on the user computing device to receive input that is evaluated to determine whether the task was completed based data included in the input indicating user interaction via the graphical user interface; and
blocking the action until it is determined that the task was completed within the temporal window, and upon determination that the task was completed during the temporal window, performing at least part of the action, and in response blocking the action.

22. (canceled)

23. The method of claim 21, wherein the action is making a purchase with a credit card from a merchant, and wherein determining that the user has requested to perform an action comprises receiving a payment request from a computing device of the merchant, the computing device of the merchant not including the one or more processors and different than the user computing device.

24. The method of claim 23, wherein blocking the action comprises:
notifying a merchant computer system that the purchase is declined.

25. The method of claim 21, wherein the action is a purchase from a merchant and wherein blocking the action comprises:
causing a mobile wallet application on the user computing device to refrain from transmitting payment details to a merchant.

26. The method of claim 21, wherein the user computing device is a mobile device of the user that includes a cellular transmitter, and wherein determining that the precondition is not satisfied comprises failing to receive an indication from the computer-based game that the precondition is satisfied within the temporal window.

27. The method of claim 21, wherein the method is performed by a payment processing computer, and wherein determining that the precondition is not satisfied comprises failing to receive, over a network, an indication from user computing device that the precondition is satisfied within the temporal window.

28. The method of claim 21, wherein determining that the user has requested to perform the action comprises receiving a request to pay for a transaction at a mobile wallet application executing on the user computing device, and wherein in response to a determination that the action was not completed, causing the user computing device to display a prompt to complete the task.

29. The method of claim 21, wherein the achievement of the user in the computer-based game comprises playing the game for a predetermined amount of time, and wherein communicating with software executing on the user computing device to determine whether the task was completed comprises receiving a data structure from the user computing device indicating that the user played the game on the computing device of the user for the predetermined amount of time.

30. The method of claim 21, wherein the method further comprises receiving an identification of the task and an identification of the precondition from the user computing device.

31. The method of claim 21, wherein the method further comprises retrieving financial data about the user over a network, and wherein the achievement of the user in the computer-based game changes depending on a past amount spent by the user as determined from the financial data of the user.
